(19) United States
(12) Patent Application Publication
(10) Pub. No.: US 2009/0313477 A1
(43) Pub. Date: Dec. 17, 2009

(54) DVR SERVER AND METHOD FOR CONTROLLING ACCESS TO MONITORING DEVICE IN NETWORK-BASED DVR SYSTEM

(75) Inventors: Ran Kyoung Park, Gyeonggi (KR); Gwang Soek Jeon, Seoul (KR); Sung Bong Cho, Seoul (KR); Bo Kyun Jeoung, Gyeonggi (KR)

Correspondence Address: BLANK ROME LLP, WATERGATE, 600 NEW HAMPSHIRE AVENUE, N.W., WASHINGTON, DC, 20037, US

(73) Assignee: Posdata Co., Ltd.

(21) Appl. No.: 12/306,627

(22) PCT Filed: Jun. 29, 2007
(86) PCT No.: PCT/KR07/03183

§ 371 Date: Dec. 24, 2008

(30) Foreign Application Priority Data
Jun. 30, 2006 (KR) 10-2006-0061022

(51) Int. Cl. H04L 9/32

(52) U.S. Cl. 713/182; 726/6

(57) ABSTRACT

The present invention provides a Digital Video Recorder (DVR) server and a method for controlling access to a monitoring device in a network-based DVR system, which only performs a user authentication in the DVR server and allows a direct access to a video providing unit by using an authentication token acquired from the authentication procedure, so that traffic of the DVR server can be reduced to maintain security while providing a smooth monitoring service.

### TECHNICAL FIELD

The present invention relates to a Digital Video Recorder (DVR) server and a method for controlling access to a monitoring device in a network-based DVR system.

### BACKGROUND ART

FIG. 1 is a diagram illustrating a conventional monitoring system. Referring to FIG. 1, most first-generation monitoring systems utilized closed circuit TVs (CCTVs) and so forth. However, a monitoring system using CCTV basically operates in such manner that it receives video picked up by a camera through a coaxial cable and outputs them on a display unit. Thus, it is actually not a telemonitoring system. Also, it uses a recording medium such as a magnetic tape or the like for recording the videos so that it not only causes a video quality to be degraded, but also requires a lot of time for searching for desired videos when recording is performed several times. Also, it is very difficult to perform general system management, such as exchange of magnetic tapes, when there is no operator stationed at the monitoring system.

As an alternative to the CCTV monitoring system based on the analog type, a second-generation DVR system was contrived. The DVR system converts video data into digital data and stores it in a hard disk or the like, so that the video quality at the time of recording and reproduction is not changed and the storage can be easily managed. Also, the DVR system can use the Internet to monitor specific locations by means of video and audio, even from a remote place, while simultaneously storing the video and audio for subsequent precise analysis, so that such DVR system can be employed as a very important application for security.

Meanwhile, the volume of video data to be stored in the DVR system has recently increased, and thus a third-generation network-based DVR system for effective management, which stores a plurality of video data picked up by a plurality of cameras in a mass storage having tens of terabytes or more (i.e., a storing device) and controls access to the video data stored in the mass storage using its central DVR server to provide a monitoring service, has recently been disclosed.

However, such network-based DVR system is simply a conventional DVR system added with a networking function, so that it not only causes a high network load on the DVR server, but also has weak security. These problems will be described in detail as follows.

First, it is normal for the central DVR server of the network-based DVR system to allow only users having an authenticated authority to access video data picked up by cameras, so that security and monitoring of the video data can be intensively controlled.

Such a video data access approach using the DVR server can easily manage the authentication of the user, but the DVR server must control access to video data picked up by all cameras, and thus high network loads are disadvantageously focused on the DVR server as described below.

For example, when the user accesses the DVR server through a client terminal to monitor a first-floor hallway from 09:00 to 18:00, video data picked up by the first-floor hallway camera is transmitted to the client terminal through the DVR server, and at this time, even when the DVR server is only in charge of transmission of the video data picked up by the first-floor hallway camera, that is, even when the client terminal substantially receives the video data from the first-floor hallway camera, resource allocation for maintaining an unnecessary session and providing a video streaming service is made between the client terminal and the DVR server, and thus unnecessary network loads occur on the DVR server.

In addition, in the conventional network-based DVR system, when the user accesses the DVR server through the client terminal to monitor a roof while monitoring the first-floor hallway, that is, when an object to be monitored is changed, the object is changed through message transmission and reception between the client terminal [symbol] DVR server [symbol] roof camera even when the monitoring object can be changed by message transmission and reception between the client terminal and the roof camera, and thus unnecessary network loads occur on the DVR server.

Particularly, in the DVR system, changes of the monitoring object frequently occur due to its inherent properties, and such video data access approach using the DVR server includes overload factors with respect to the changes in monitoring object, and thus it is not preferable in view of effectiveness of the DVR server.

Second, such network-based DVR system is generally a password-based user authentication mechanism performing user authentication, and the user authentication technique using the password is a mechanism employed by most actual authentication systems but is vulnerable to external exposure, guesswork, wire-tapping, recurrence and so forth, so that video data including individual privacies may be abused when the passwords are exposed on the network, and it is burdensome from the viewpoint of a user because the user ID and PW need to be input whenever the user accesses the DVR server.

To make up for such problems, a method is disclosed which transceives an encrypted public key without using a password to perform user authentication. However, it requires a user to hold a smart card or the like containing a certificate or secret key of the user, and requires much effort and cost due to system complexity when a system is actually implemented, so that the method is not generally employed.

In addition, in the case of a local client terminal connected through an internal network in such a network-based DVR system, performing authentication on the local client terminal is commonly omitted due to the complexity of MAC address management and IP addresses of unspecified users and complexity of separate key management per local client for terminal authentication. However, such an authentication policy is not favored in terms of security that requires a limited monitoring service to be provided to only authenticated users.

In conclusion, a technique is needed which is capable of distributing network loads of the DVR server, thereby supporting a smooth monitoring service without a large overload, while maintaining security without undergoing a complex and burdensome user authentication procedure in the network-based DVR system.

### DISCLOSURE OF INVENTION

### Technical Problem

In order to solve the foregoing and/or other problems, it is an object of the present invention to provide a method of controlling access to a monitoring target terminal of a user for reducing load on a network and a DVR server in a network-based DVR system.

It is another object of the present invention to provide a method of controlling access to a monitoring target terminal by a user which allows a real time multimedia monitoring service to be provided directly from the monitoring target terminal.

It is still another object of the present invention to provide a method of controlling access to a monitoring target terminal by a user which can implement effective security by allowing only an authenticated user to access the monitoring target terminal.

It is yet another object of the present invention to provide a DVR server controlling access to a monitoring target terminal by a user for reducing load on a network and a DVR server in a network-based DVR system.

It is yet another object of the present invention to provide a DVR server for controlling access to a monitoring target terminal by a user which allows a real time multimedia monitoring service to be provided directly from the monitoring target terminal.

It is yet another object of the present invention to provide a DVR server for controlling user access to a monitoring target terminal to implement effective security by allowing only an authenticated user to access the monitoring target terminal.

### Technical Solution

In one aspect, the invention is directed to a method of controlling access to a monitoring target terminal by a client terminal connected to a Digital Video Recorder (DVR) server through a network in a network-based DVR system, the method comprising the steps of: (a) performing authentication on a user of the client terminal; (b) providing a server authentication token when the authentication for the user of the client terminal is valid; (c) providing a terminal authentication token required for accessing the monitoring target terminal to the client terminal; and (d) accessing the corresponding monitoring target terminal using the provided terminal authentication token.

In another aspect, the invention is directed to a method of controlling access to a monitoring target terminal through a client terminal connected to a Digital Video Recorder (DVR) server through a network in a network-based DVR system, the method comprising the steps of: (a) performing authentication on a user of the client terminal; (b) providing a server authentication token to the client terminal if the authentication for the user of the client terminal is valid; and (c) accessing the corresponding monitoring target terminal using the provided server authentication token.

In still another aspect, the invention is directed to a method of controlling access to a monitoring target terminal or a multimedia storing unit using a client terminal in a Digital Video Recorder (DVR) system including at least one monitoring target terminal, at least one client terminal, a multimedia storing unit and a DVR server, connected to each other through a network, the method comprising the steps of: requesting user authentication of the client terminal to the DVR server; receiving a server authentication token if the user authentication of the client terminal from the DVR server is valid; requesting a terminal authentication token required for accessing the selected monitoring target terminal or the multimedia storing unit and receiving the terminal authentication token; and requesting access to the corresponding monitoring target terminal using the terminal authentication token.

In yet another aspect, the invention is directed to a DVR server in a network-based Digital Video Recorder (DVR) system including at least one monitoring target terminal, at least one client terminal, and the DVR server connected to each other through a network, the DVR server comprising: a communication unit for communicating with an external side; an authentication and security control unit for controlling user authentication and security; an authentication token generation unit for generating a server authentication token proving that a user of the client terminal is a valid user and a terminal authentication token proving that the user is one accessible to the monitoring target terminal under the control of the authentication and security control unit; and an authentication token verification unit for verifying whether the server authentication token and the terminal authentication token provided by the user of the client terminal user are valid under the control of the authentication and security control unit.

### ADVANTAGEOUS EFFECTS

According to the present invention as described above, a substantial multimedia monitoring service can be provided directly from each monitoring target terminal without going through a DVR server in a network-based DVR system, so that traffic of the DVR server can be reduced, thereby supporting a smooth monitoring service without a large overload while maintaining security.

In addition, according to the present invention, when access to a DVR server or a monitoring target terminal from a user is requested, a server authentication token or a terminal authentication token held by the user is checked and an access authentication procedure is performed thereon, so that security can be maintained without undergoing a complex and burdensome user authentication procedure.

### BRIEF DESCRIPTION OF THE DRAWINGS

The above and other aspects and advantages of the present invention will become apparent and more readily appreciated from the following description of exemplary embodiments, taken in conjunction with the accompanying drawings, in which:

FIG. 1 is a diagram illustrating a conventional monitoring system;

FIG. 2 is a diagram schematically illustrating a configuration of a network-based DVR system to which the present invention is applied;

FIG. 3 is a block diagram illustrating access control device of a DVR server in accordance with the present invention;

FIG. 4 is a diagram illustrating operations of a DVR server in accordance with the present invention;

FIG. 5A is a diagram illustrating an example of a server authentication token table stored in a memory of FIG. 3;

FIG. 5B is a diagram illustrating an example of a terminal authentication token table stored in a memory of FIG. 3;

FIG. 6 is a flowchart illustrating a method of controlling access to a monitoring target terminal in accordance with a first embodiment of the present invention; and

FIG. 7 is a flowchart illustrating a method of controlling access to a monitoring target terminal in accordance with a second embodiment of the present invention.

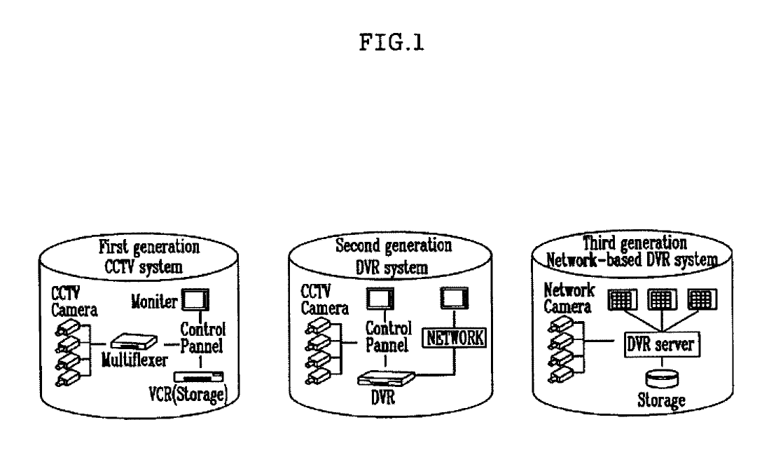

### DESCRIPTION OF MAJOR REFERENCE NUMERALS

210: Analog CCTV camera
211: Video compression and transmission device
220: Network camera
230: Storage
240: DVR server
250: Local client terminal
260: Web client terminal
300: Access control device of DVR server
310: communication unit
320: Authentication and security control unit
330: Authentication token generation unit
340: Authentication token verification unit
350: Memory
351: User authentication table
352: Server authentication token table
353: Terminal authentication token table

### MODE FOR THE INVENTION

Hereinafter, exemplary embodiments of the present invention will be described in detail with reference to the accompanying drawings.

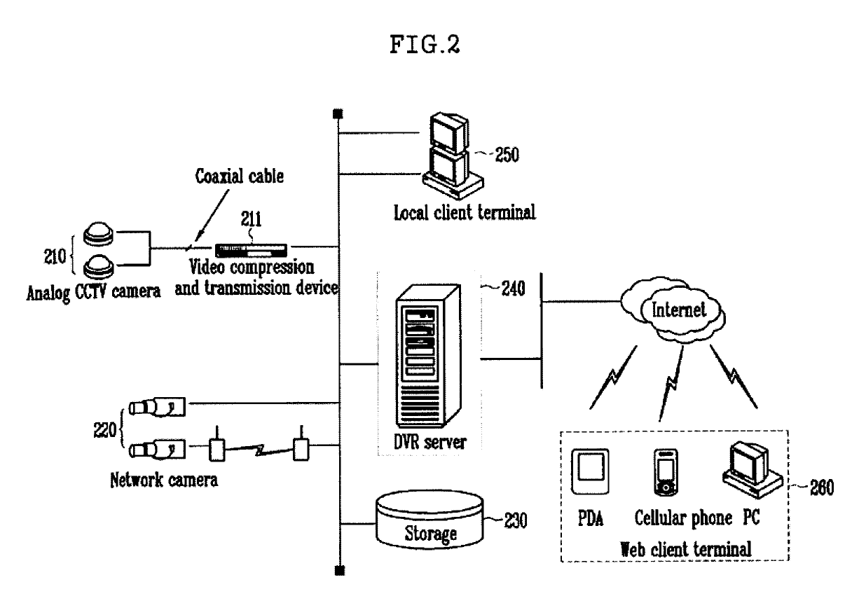

FIG. 2 is a diagram schematically illustrating a configuration of a network-based DVR system to which the present invention is applied.

As shown in FIG. 2, the network-based DVR system includes a plurality of analog CCTV cameras 210 or a plurality of network cameras 220 installed in various areas, a DVR server 240 managing a storage 230 which stores multimedia data (video data) picked up by the cameras 210, a local client terminal 250 accessible to the DVR server 240 through an internal network, and web client terminals 260, such as PDAs, cellular phones, PCs or the like, accessible to the DVR server 240 through the Internet.

Here, it is preferable to further include a video compression and transmission device 211 for compressing video data picked up by the CCTV cameras 210 and transmitting it to the DVR server 240, and a plurality of analog CCTV cameras 210 (e.g., four analog CCTV cameras) are preferably connected to the video compression and transmission device 211 through a coaxial cable.

The network cameras 220 are general CCTV cameras such as web cameras or Internet cameras added with a server function, and are connected to the DVR server 240 through a wired/wireless IP network.

The storage 230 preferably has a mass storage capacity of tens of terabytes or more.

In the present embodiment, the local client terminal 250 or the web client terminal 260 is collectively referred to as a client terminal, and objects to be monitored, such as several analog CCTV cameras 210 or several network cameras 220, and the storage 230 in which multimedia data picked up by the cameras 210 and 220 is stored, are collectively referred to as a monitoring target terminal.

Meanwhile, in the network-based DVR system having the configuration as shown in FIG. 2, the approach of collectively controlling security and monitoring in the central DVR server 240 causes a high network load to be focused on the DVR server 240, and thus it is not effective and is not preferable in terms of the burdensome log-in procedure and security as described above.

Accordingly, the DVR server 240 of the present invention performs user authentication only and utilizes an authentication token acquired from the authentication procedure to receive a direct monitoring service from each analog CCTV camera 210 or network camera 220, so that traffic of the DVR server 240 can be reduced, thereby supporting a smooth monitoring service without a large overload while maintaining the security without undergoing the burdensome log-in procedure. Hereinafter, a device of controlling access to the DVR server according to the present invention will be described in more detail.

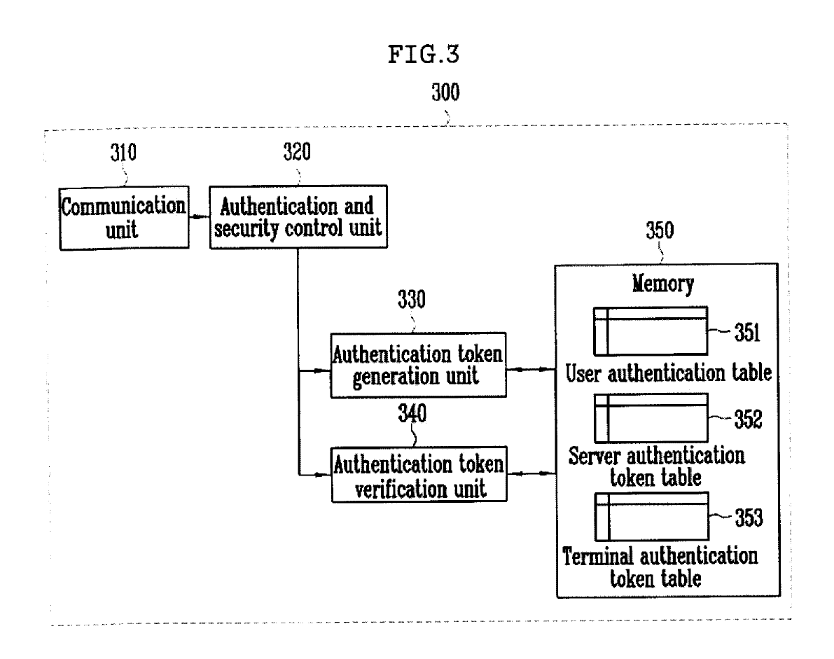

FIG. 3 is a block diagram illustrating an access control device of a DVR server in accordance with the present invention.

As shown in FIG. 3, the access control device 300 of the DVR server according to the present invention includes a communication unit 310 for communication with an external side, an authentication and security control unit 320 for controlling user authentication and security, an authentication token generation unit 330 for generating a server authentication token capable of proving the authenticated user and a terminal authentication token capable of proving the user to be one who has access to the monitoring target terminal under the control of the authentication and security control unit 320, an authentication token verification unit 340 for verifying validities of the terminal authentication token and the server authentication token provided from the user under the control of authentication and security control unit 320, and a memory 350 in which user information and various information about authentication tokens generated by the authentication token generation unit 330 is stored.

Here, the access control device 300 is preferably included in the DVR server 240 shown in FIG. 2, and it is assumed that the access control device 300 is included in the DVR 240 for simplicity of description.

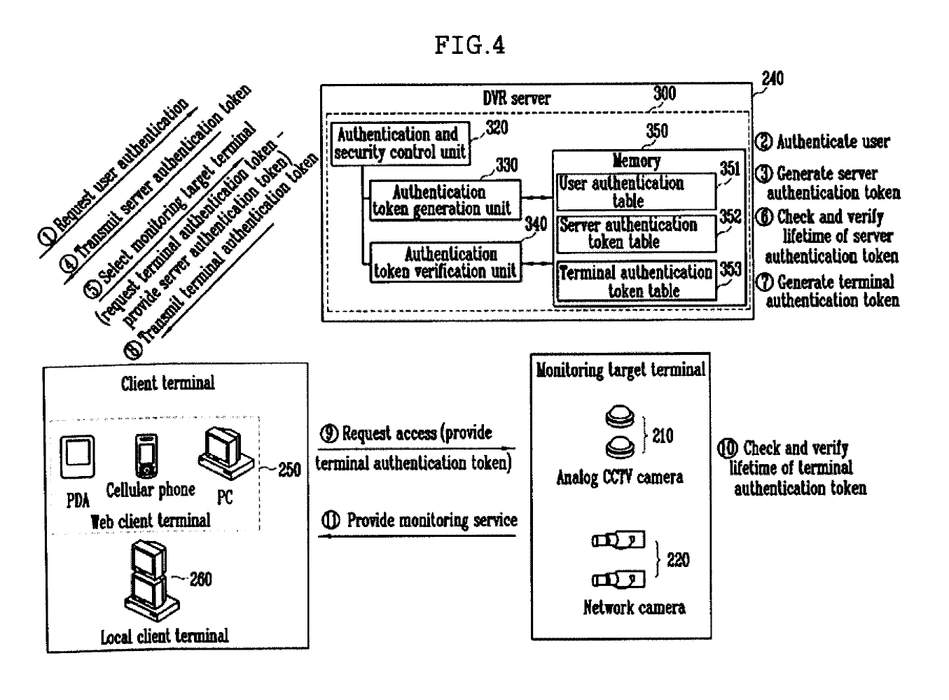

Hereinafter, operations of the DVR server 240 according to the present invention will be described in more detail with reference to FIG. 4.

FIG. 4 is a diagram illustrating operations of a DVR server in accordance with the present invention.

Referring to FIG. 4, when the user first accesses the DVR server 240 through the client terminals 250 and 260, the DVR server 240 requires the user to input an Identification (ID) and a Password (PW).

When the user inputs the ID and the PW through the client terminals 250 and 260, the input ID and PW information is transmitted to the DVR server 240 through the Internet, so that the DVR server 240 performs user authentication by searching for the ID and PW information in the user authentication table 351 of the memory 350 under the control of authentication and security control unit 320.

At this time, user registration information such as ID, PW, and authority information of the user, is preferably recorded in the user authentication table 351, and it is preferable to perform a challenge and response type of password-based user authentication as the user authentication procedure.

Herein, a hashed code of the password can be recorded in the user authentication table in case of the challenge and response type of password-based user authentication.

When the user authentication is valid, the DVR server 240 generates a server authentication token (Auth_token_Server) proving that the user is an authenticated user capable of accessing the DVR server 240, and the Auth_token_Server is generated by Equation 1 below.

Auth_token_Server=Enc_{ATK}(Mac_addr_Server∥Timestamp_Server) [Equation 1]

Referring to Equation 1, Enc_{ATK} indicates an encryption/decryption key for generating and verifying an authentication token, Mac_addr_Server indicates unique information allowing the DVR server 240 to be identified, e.g., a MAC address of the DVR server 240, Timestamp_Server indicates a generation time of the server authentication token, and ∥ indicates concatenation.

That is, Equation 1 encrypts the MAC address (Mac_addr_Server) of the DVR server 240 and the generation time information (Timestamp_Server) of the server authentication token with Enc_{ATK}, so that the server authentication token (Auth_token_Server) proving that the user is the authenticated user capable of accessing the DVR server 240 is generated.

When the server authentication token (Auth_token_Server) is generated by the above-described procedure, the DVR server 240 includes the generated server authentication token (Auth_token_Server) in an authentication success message and transmits the message to the users of the client terminals 250 and 260.

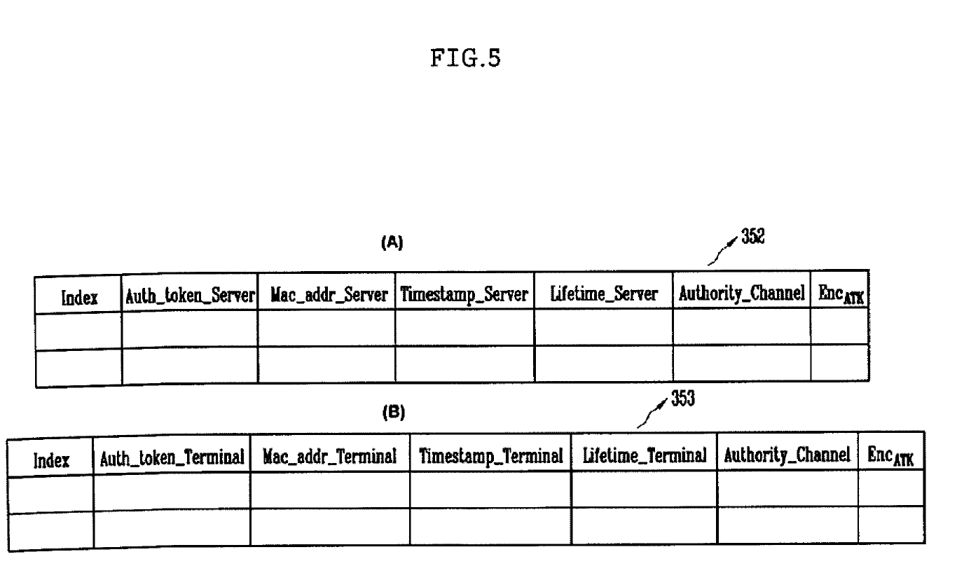

Meanwhile, the DVR server 240 stores information on the generated server authentication token (Auth_token_Server) in the server authentication token table 352 of the memory 350. Hereinafter, the server authentication token table 352 will be described in more detail with reference to FIG. 5A. But the information can not be stored in the server authentication token table 352 for DVR server operation.

FIG. 5A is a diagram illustrating an example of the server authentication token table 352 stored in a memory 350 of FIG. 3.

As shown in FIG. 5A, a server authentication token (Auth_token_Server) is recorded per index in the server authentication token table 352, and other information about a MAC address (Mac_addr_Server) of the DVR server 240, a generation time (Timestamp_Server) of the server authentication token, a lifetime (Lifetime_Server) of the server authentication token, channel authority information (Authority_Channel) of the user, encryption/decryption key (Enc_{ATK}) for generating and verifying an authentication token, is stored in the table.

Referring again to FIG. 4, when the client terminals 250 and 260 receive authentication success messages from the DVR server 240, the client terminal extracts a server authentication token from the received authentication success message and stores it, and at this time, the server authentication token is preferably stored after integrity of the received server authentication token (Auth_token_Server) is verified.

When the user selects a monitoring target terminal (e.g., a first-floor hallway camera, a third-floor lounge camera, a roof camera) through the client terminal 250 and 260, the client terminal 250 and 260 transmits an authority required for accessing the selected monitoring target terminal, that is, a message requesting a terminal authentication token, to the DVR server 240, and the message requesting the terminal authentication token (Auth_token_request) can be expressed as Equation 2 below.

Auth_token_request(User_ID,Mac_addr_client,Auth_token_Server,N,List_Mac,MAC(KEK∥List_Mac)) [Equation 2]

Referring to Equation 2, User_ID indicates a user ID, Mac_addr_client indicates a MAC address of the client terminal, Auth_token_Server indicates a server authentication token held by the client terminal user, N indicates the number of monitoring target terminals, List_Mac indicates a MAC address list of the monitoring target terminal, and MAC(KEK∥List_Mac) indicates a message authentication code (Message authentication code) resulting from that the MAC address list (List_Mac) of the monitoring target terminal is encrypted with a Key Encryption Key (KEK) or a public key between the client terminals 250 and 260 and the DVR server 240.

Meanwhile, when the DVR server 240 receives the terminal authentication token request message (Auth_token_request) from the client terminals 250 and 260 as shown in FIG. 2, the DVR server checks and verifies the lifetime of the server authentication token (Auth_token_Server) included in the terminal authentication token request message, and hereinafter, the lifetime check and verification of the server authentication token (Auth_token_Server) will be described in more detail.

First, since the received server authentication token (Auth_token_Server) is already encrypted, the authentication token verification unit 340 inversely uses Equation 1 to decrypt the server authentication token (Auth_token_Server) with Enc_{ATK}, so that the MAC address (Mac_addr_Server) of the DVR server 240 and the generation time (Timestamp_Server) of the server authentication token (Auth_token_Server) are extracted.

The DVR server 240 then checks the lifetime of the server authentication token (Auth_token_Server) based on the extracted generation time information (Timestamp_Server) of the server authentication token to determine whether the server authentication token (Auth_token_Server) is valid, and at this time, it is preferable to also check whether the extracted MAC address (Mac_addr_Server) of the DVR server 240 is identical.

The authentication token verification unit 340 then checks the lifetime information (Lifetime_Server) of the server authentication token in the server authentication token table 352 based on the extracted generation time (Timestamp_Server) of the server authentication token to determine whether the server authentication token (Auth_token_Server) is valid.

That is, the server authentication token (Auth_token_Server) is determined to be valid when the current checked time<generation time (Timestamp_Server) of the server authentication token+lifetime (Lifetime_Server) of the server authentication token, or is determined vice versa to be invalid.

At this time, it is preferable to also check whether the extracted MAC address (Mac_addr_Server) of the DVR server 240 is identical.

Next, when the server authentication token (Auth_token_Server) is determined to be valid, the authentication token verification unit 340 checks message authentication code included in the terminal authentication token request message (Auth_token_request) to verify integrity of the server authentication token (Auth_token_Server), which will be described in more detail below.

The authentication token verification unit 340 first encrypts the MAC address list (List_Mac) of the monitoring target terminal included in the terminal authentication token request message (Auth_token_request) with a KEK or a public key of the DVR server 240, to generate a message authentication code (Message authentication code).

Here, the KEK is preferably a public key between the DVR server 240 and the client terminals 250 and 260.

The authentication token verification unit 340 determines that the server authentication token (Auth_token_Server) has integrity when the generated message authentication code (Message authentication code) is identical to the message authentication code (Message authentication code) included in the terminal authentication token request message (Auth_token_request) or determines vice versa that the server authentication token may have been modulated.

As such, when it is determined that the lifetime of the server authentication token (Auth_token_Server) is expired to be an invalid server authentication token or that the server authentication token (Auth_token_Server) may have been modulated, the DVR server 240 makes a request for re-inputting the ID and PW of the user to the user of the client terminal, thereby re-issuing the server authentication token (Auth_token_Server).

Meanwhile, when it is determined that the server authentication token (Auth_token_Server) is valid and has integrity in accordance with the lifetime check and verification procedure of the server authentication token (Auth_token_Server) as described above, the DVR server 240 generates a terminal authentication token (Auth_token_Terminal) required for accessing the corresponding monitoring target terminal per each monitoring target terminal through the authentication token generation unit 330. The terminal authentication token (Auth_token_Terminal) is generated by Equation 3.

Auth_token_Terminal=Enc_{ATK}(Mac_addr_Terminal∥Timestamp_Terminal∥Authority_Channel) [Equation 3]

In Equation 3, Enc_{ATK} indicates an encryption/decryption key for generating and verifying an authentication token, Mac_addr_Terminal indicates a MAC address of the monitoring target terminal, Timestamp_Terminal indicates a generation time of the terminal authentication token, Authority_Channel indicates channel authority information of a camera accessible by the user, and ∥ indicates concatenation.

That is, Equation 3 indicates that the MAC address (Mac_addr_Terminal) of the monitoring target terminal, the generation time of the terminal authentication token (Timestamp_Terminal), and channel authority information (Authority_Channel) are encrypted with Enc_{ATK}, so that a terminal authentication token (Auth_token_Terminal) capable of proving that the user is one who can receive the monitoring service from the corresponding monitoring target terminal is generated.

Here, when the monitoring target terminal is the storage 230, that is, when the user accesses the storage 230 to search multimedia data stored in the storage 230, the channel authority information is not required, so that the channel authority information is preferably set to Null in Equation 3.

That is, it can be understood from Equation 3 that the authentication token is generated by the same manner except that an object requested for access in Equation 1 as the monitoring target terminal is not the DVR server 240 but the cameras 210 and 220 or the storage 230, and the resultant channel authority information among information for encryption is added.

Meanwhile, the DVR server 240 stores information about the generated terminal authentication token (Auth_token_Terminal) in the terminal authentication token table 353 of the memory 350, which will be described in more detail with reference to FIG. 5B. But the information can not be stored in the terminal authentication token table 352 for DVR server operation.

FIG. 5B is a diagram illustrating an example of a terminal authentication token table 353 stored in a memory 350 of FIG. 3.

As shown in FIG. 5B, terminal authentication tokens (Auth_token_Terminal) are recorded per index in the terminal authentication token table 353, and other information about a MAC address (Mac_addr_Terminal) of the monitoring target terminal, a generation time (Timestamp_Terminal) of the terminal authentication token, a lifetime (Lifetime_Terminal) of the terminal authentication token, channel authority information (Authority_Channel) of the user, and an encryption/decryption key (Enc_{ATK}) for generating and verifying an authentication token is stored.

Here, the channel authority information of the user (Authority_Channel) means a channel list of cameras accessible by the user, and this channel authority information enables the user to check which camera is accessible, and the channel authority information on the device such as DVR server 240 or storage 230 other than the camera is preferably set to Null.

Meanwhile, when the terminal authentication token required for accessing the corresponding monitoring target terminal is generated in accordance with the above-described procedure, the DVR server 240 includes the generated terminal authentication token in the terminal authentication token transmission message (Auth_token_reply) and delivers the message to the user of the client terminal. The terminal authentication token transmission message (Auth_token_reply) can be expressed as Equation 4.

Auth_token_reply(User_ID,Timestamp_Terminal,N,List_Mac,List_Auth_token_Terminal,MAC(KEK∥List_Auth_token_Terminal)) [Equation 4]

In Equation 4, User_ID indicates a user ID, Timestamp_Terminal indicates a generation time of the terminal authentication token, N indicates the number of monitoring target terminals, List_Mac indicates a MAC address list of the monitoring target terminals, List_Auth_token_Terminal indicates a terminal authentication token list, and MAC(KEK∥List_Auth_token_Terminal) indicates a message authentication code (Message authentication code) resulting from that the terminal authentication token list (List_Auth_token_Terminal) is encrypted with a KEK, a public key between the DVR server 240 and the client terminals 250 and 260.

That is, authentication code information about the user ID, the generation time of the terminal authentication token, the number of the monitoring target terminals, MAC address list of the monitoring target terminals, and the terminal authentication token list and terminal authentication token list, is included in the terminal authentication token transmission message (Auth_token_reply).

Meanwhile, when the client terminals 250 and 260 receive the terminal authentication token transmission message (Auth_token_reply) from the DVR server 240, the client terminals 250 and 260 extract the terminal authentication token (Auth_token_Terminal) from the received terminal authentication token transmission message and store it, and at this time, lifetime check and verification of the terminal authentication token (Auth_token_Terminal) are preferably performed. The lifetime check and verification of the terminal authentication token (Auth_token_Terminal) are performed in the same way as those of the server authentication token (Auth_token_Server), and thus a detailed description thereof will be omitted.

Next, when the user requests access to the monitoring target terminal (e.g., a first-floor hallway camera), the client terminals 250 and 260 transmit their access request messages to the corresponding monitoring target terminals, and at this time, a terminal authentication token required for accessing the corresponding monitoring target terminal is preferably included in the access request message.

That is, the user of the client terminal provides the terminal authentication token (Auth_token_Terminal) held by the user to the corresponding monitoring target terminal to request access, and the monitoring target terminal, upon receipt of the request for access, performs lifetime check and verification of the received terminal authentication token and allows the user to gain access to provide a monitoring service to the user when the received terminal authentication token is determined to be valid and to have integrity.

Here, when it is determined that the lifetime of the terminal authentication token (Auth_token_Terminal) is expired, that is, an invalid terminal authentication token, or the terminal authentication token (Auth_token_Terminal) may have been modulated, the DVR server 240 preferably re-issues the terminal authentication token (Auth_token_Terminal).

As such, the DVR server 240 according to the present invention provides a server authentication token required for accessing a server and a terminal authentication token required for accessing a monitoring target terminal to an authenticated user, and the monitoring target terminal requested for access checks, when the access to the monitoring target terminal is requested from the user, the terminal authentication token held by the user to perform an access authorization procedure thereon, so that a substantial multimedia monitoring service can be provided from each monitoring target terminal without going through the DVR server 240, thereby minimizing traffic focused on the DVR server 240, thereby supporting a smooth monitoring service without a large overload while maintaining security.

In addition, according to the present invention, when access to the DVR server or monitoring target terminal from the user is requested, the server authentication token or terminal authentication token held by the user is checked and then an access authorization procedure is performed thereon, so that security can be maintained without undergoing a complex and burdensome user authentication procedure.

Hereinafter, a method of controlling access to a monitoring target terminal according to the present invention will be described in detail with reference to accompanying drawings.

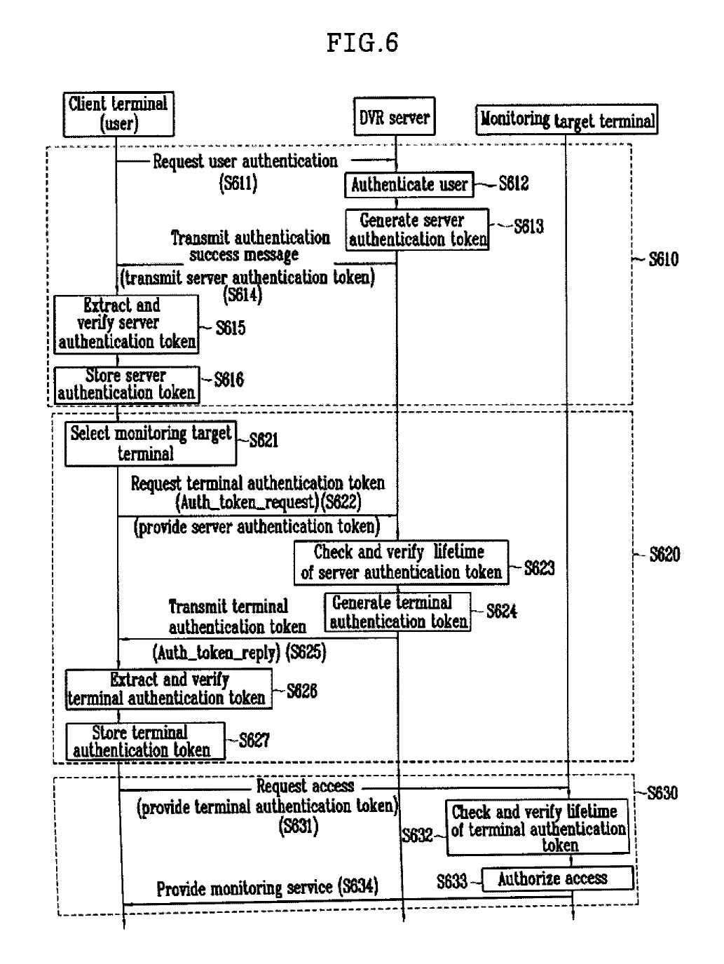

FIG. 6 is a flowchart illustrating a method of controlling access to a monitoring target terminal in accordance with a first embodiment of the present invention.

Referring to FIG. 6, the method controlling access to a monitoring target terminal according to the present invention includes providing a server authentication token (S610) capable of proving an authenticated user to a client terminal user, providing a terminal authentication token (S620) capable of proving a user capable of accessing the monitoring target terminal to the client terminal user, and accessing the corresponding monitoring target terminal using the provided terminal authentication token to provide a monitoring service, and each step will be described as follows.

(1) Step of Providing Server Authentication Token (S610)

When the user first inputs an ID and a PW on a client terminal, the client terminal then makes a request for user authentication to the DVR server 240 (S611), so that the DVR server 240 performs the user authentication in accordance with the predetermined authentication and security policy (S612).

The DVR server 240, when the authentication for the user is successful, encrypts its MAC address (i.e., MAC address of the DVR server 240) and current time (i.e., generation time of server authentication token) information with an encryption/decryption key (Enc_{ATK}) for generating and verifying an authentication token to generate a server authentication token (Auth_token_Server) (S613).

Here, the server authentication token (Auth_token_Server) acts to prove that the user is the authenticated user capable of accessing the DVR server 240. A method of generating the server authentication token (Auth_token_Server) has already been described in detail with reference to Equation 1, and thus a detailed description thereof will be omitted.

The DVR server 240 then includes the generated server authentication token (Auth_token_Server) in an authentication success message and transmits the message to the user (S614).

At this time, information about the generated server authentication token (Auth_token_Server) is preferably stored in the server authentication token table 352 as shown in FIG. 5A. But the generated server authentication token can not be stored.

Meanwhile, the client terminals 250 and 260, upon receipt of the authentication success message from the DVR server 240, extract the server authentication tokens (Auth_token_Server) from the received authentication success messages, and then verify integrity of the extracted server authentication tokens (Auth_token_Server) (S615).

Here, a method of verifying data integrity using a Message authentication code (MAC) algorithm is preferably used as the method of verifying the integrity of the server authentication token (Auth_token_Server).

When the server authentication token (Auth_token_Server) is checked to have the integrity, the client terminals 250 and 260 store the server authentication tokens (Auth_token_Server) in their internal memories (S616).

(2) Step of Providing Terminal Authentication Token (S620)

When the user first selects a monitoring target terminal (e.g., a first-floor hallway camera, a third-floor lounge camera, a roof camera or the like) through the client terminal 250 and 260 (S621), the client terminal 250 and 260 transmits, to the DVR server 240, a terminal authentication token request message (Auth_token_request) (see Equation 2) requesting a terminal authentication token required for accessing the selected monitoring target terminal (S622).

At this time, as shown in Equation 2, a user ID (User_ID), a MAC address of the client terminal (Mac_addr_client), a server authentication token held by the client terminal user (Auth_token_Server), the number of monitoring target terminals (N), a MAC address list of the monitoring target terminals (List_Mac), and a message authentication code (MAC(KEK∥List_Mac), resulting from that the MAC address list of the monitoring target terminals (List_Mac) is encrypted with a KEK or a public key between the DVR server 240 and the client terminals 250 and 260, are preferably included in the terminal authentication token request message (Auth_token_request).

Next, the DVR server 240, upon receipt of the terminal authentication token request message (Auth_token_request) from the client terminals 250 and 260, performs lifetime check and verification of the server authentication token (Auth_token_Server) included in the terminal authentication token request message (Auth_token_request) (S623). The lifetime check and verification of the server authentication token (Auth_token_Server) will be briefly described as follows.

The DVR server 240 inversely uses Equation 1 to decrypt the server authentication token (Auth_token_Server) with Enc_{ATK}, so that the MAC address (Mac_addr_Server) of the DVR server 240 and generation time information of the server authentication token are extracted.

The DVR server 240 then checks the lifetime information (Lifetime_Server) of the server authentication token in the server authentication token table 352 based on the generation time information (Timestamp_Server) of the extracted server authentication token to determine whether the server authentication token (Auth_token_Server) is valid, and at this time, it is preferable to also check whether the extracted MAC address (Mac_addr_Server) of the DVR server 240 is identical.

The DVR server 240 encrypts the MAC address list (List_Mac) of the monitoring target terminal included in the terminal authentication token request message (Auth_token_request) with a KEK or a public key of the DVR server 240, when the server authentication token (Auth_token_Server) is determined to be valid, and determines that the server authentication token (Auth_token_Server) has integrity when the generated message authentication code (Message authentication code) is identical to the message authentication code (Message authentication code) included in the terminal authentication token request message (Auth_token_request), or determines vice versa that the server authentication token may have been modulated.

Here, when it is determined that the lifetime of the server authentication token (Auth_token_Server) is expired to be invalid or that the server authentication token (Auth_token_Server) may have been modulated, the DVR server 240 has the client terminal user re-input the user ID and PW to re-issue the server authentication token (Auth_token_Server).

Meanwhile, when the server authentication token (Auth_token_Server) is determined to be valid and have integrity in accordance with the above-described lifetime check and verification of the server authentication token (Auth_token_Server), the DVR server 240 generates an authority required for accessing a monitoring target terminal per monitoring target terminal, that is, a terminal authentication token (Auth_token_Terminal).

Here, the terminal authentication token (Auth_token_Terminal) acts to prove that the user is one capable of receiving a monitoring service from the corresponding monitoring target terminal, and is generated by encrypting the MAC address of the monitoring target terminal, the current time (generation time of the terminal authentication token), and the channel authority information of the camera capable of being accessed by the user, with the encryption/decryption key (Enc_{ATK}) for generating and verifying the authentication token. The method of generating the terminal authentication token (Auth_token_Terminal) has already been described in detail with reference to Equation 3, and thus a detailed description thereof will be omitted.

When the terminal authentication token required for accessing each monitoring target terminal is generated by the above-described procedure, the DVR server 240 includes the plurality of terminal authentication tokens in the terminal authentication token transmission message (Auth_token_reply) and transmits the message to the user of the client terminal (S265).

At this time, as shown in Equation 4, the user ID, generation time of terminal authentication token, number of monitoring target terminals, MAC address list of the monitoring target terminal, terminal authentication token list, and authentication code information about the terminal authentication token list are preferably included in the terminal authentication token transmission message (Auth_token_reply).

Meanwhile, the information about the generated terminal authentication token (Auth_token_Terminal) is preferably included in the terminal authentication token table 353 as shown in FIG. 5B. But the information can not be included.

The client terminals 250 and 260, upon receipt of the terminal authentication token transmission messages (Auth_token_reply) from the DVR server 240, extract the terminal authentication tokens (Auth_token_Terminal) from the received terminal authentication token transmission message (Auth_token_reply) and then verify integrity of the extracted terminal authentication tokens (Auth_token_Terminal) (S626). This method of verifying the integrity of the extracted terminal authentication token (Auth_token_Terminal) is performed in the same manner as the verification of the integrity of the server authentication token (Auth_token_Server), and thus a detailed description thereof will be omitted.

When it is checked that the terminal authentication token (Auth_token_Terminal) has the integrity, the client terminals 250 and 260 store the terminal authentication token (Auth_token_Terminal) in its internal memory (S627).

(3) Step of Providing Monitoring Service (S630)

When the monitoring target terminal (e.g., a first-floor hallway camera) is selected by the user while the terminal authentication token allowing the user to access the corresponding monitoring target terminal is provided to the client terminal user by the above-described step of providing the terminal authentication token (S620), the client terminals 250 and 260 transmit the access request message to the corresponding monitoring target terminal (S631), and at this time, a terminal authentication token required for accessing the corresponding monitoring target terminal is preferably included in the access request message.

The monitoring target terminal, upon receipt of the access request message from the client terminals 250 and 260, performs lifetime check and verification of the terminal authentication token (Auth_token_Terminal) included in the access request message (S632), and applies access to the client terminal when the terminal authentication token is determined to be valid and to have integrity (S632), thereby providing a monitoring service to the client terminal user (S633 to S634).

Here, when the lifetime of the terminal authentication token (Auth_token_Terminal) is expired, that is, an invalid terminal authentication token, or the terminal authentication token (Auth_token_Terminal) may have been modulated, the monitoring target terminal requests the DVR server 240 that the terminal authentication token (Auth_token_Terminal) be issued again.

It has been described that the corresponding monitoring target terminal is selected from the user while the client terminal user holds the terminal authentication token allowing the client terminal user to access the monitoring target terminal. However, when the user does not hold the terminal authentication token or the monitoring target terminal is changed, it is preferable that the terminal authentication token is first provided to the user by the step of providing the terminal authentication token (S610), and then the user is allowed to access the corresponding monitoring target terminal using the provided terminal authentication token.

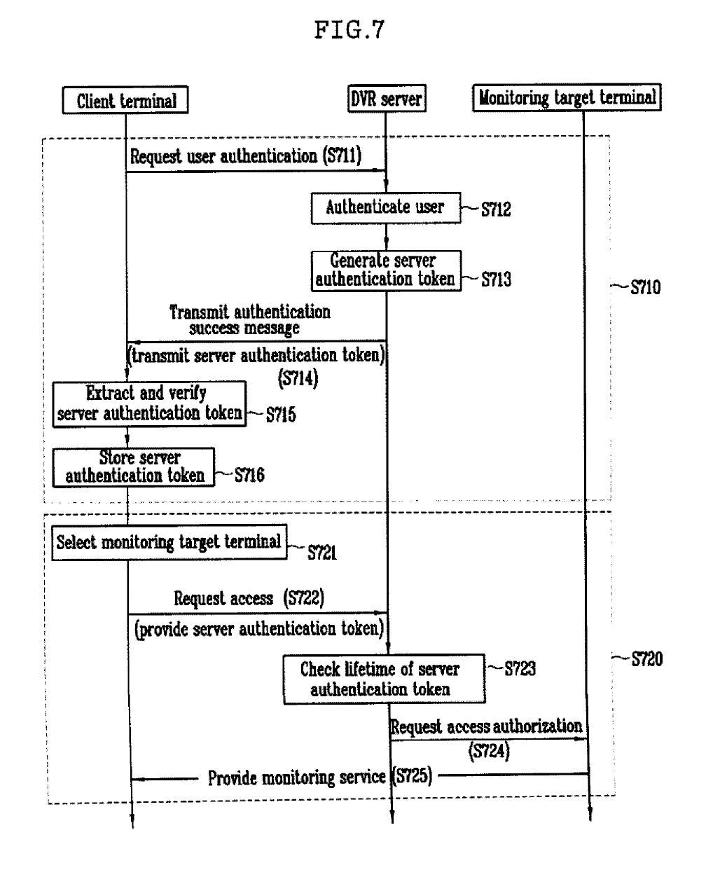

Meanwhile, it has been described that the server authentication token and the terminal authentication token are separately provided to the user, the server authentication token is used for accessing the DVR server 240, and the terminal authentication token is used for accessing the monitoring target terminal. However, the server authentication token only can be used to access the monitoring target terminal, which will be described below in more detail with reference to FIG. 7.

FIG. 7 is a flowchart illustrating a method of controlling access to a monitoring target terminal in accordance with a second embodiment of the present invention.

Referring to FIG. 7, the method of controlling access to a monitoring target terminal according to the present invention may include providing a server authentication token capable of proving an authenticated user to a client terminal user (S710), and accessing the corresponding monitoring target terminal using the provided server authentication token to provide a monitoring service (S720).

The step of providing the server authentication token (S710) is the same as the step of providing the server authentication token described with reference to FIG. 6, and thus a detailed description thereof will be omitted. The step of providing the monitoring service (S720) will be described below in more detail.

When a monitoring target terminal (e.g., a first-floor hallway camera, a third-floor lounge camera, a roof camera, or the like) is selected by a user (S721) while a server authentication token is provided to a client terminal user by the step of providing the server authentication token (S710), the client terminals 250 and 260 transmit an access request message to the DVR server 240 (S722), and at this time, the server authentication token is preferably included in the access request message.

The DVR server 240, upon receipt of the access request message from the client terminals 250 and 260, checks the lifetime of the server authentication token (Auth_token_Server) included in the access request message (S723). The lifetime check of the server authentication token (Auth_token_Server) will be briefly described as follows.

The DVR server 240 inversely uses Equation 1 to decrypt the server authentication token (Auth_token_Server) with Enc_{ATK}, so that a MAC address (Mac_addr_Server) of the DVR server 240 and generation time (Timestamp_Server) information of the server authentication token (Auth_token_Server) are extracted.

The DVR server 240 then checks the lifetime information (Lifetime_Server) of the server authentication token based on the generation time information (Timestamp_Server) of the extracted server authentication token to determine whether the server authentication token (Auth_token_Server) is valid, and at this time, it is preferable to also check whether the MAC address (Mac_addr_Server) of the extracted DVR server 240 is identical.

Here, when the lifetime of the server authentication token (Auth_token_Server) is expired, that is, an invalid server authentication token, the DVR server 240 makes a request for re-inputting the ID and PW of the client terminal user to the user, thereby re-issuing the server authentication token.

The DVR server 240 transmits an access authorization request message to the corresponding monitoring target terminal when the server authentication token (Auth_token_Server) is determined to be valid (S724).

The corresponding monitoring target terminal, upon receipt of the access authorization request message from the DVR server 240, applies access to the client terminal to provide a monitoring service to the user of the client terminal (S725).

According to a method of controlling access to a monitoring target terminal as described above, a substantial multimedia monitoring service can be provided directly from each monitoring target terminal without going through a DVR server 240, so that traffic focused on the DVR server 240 can be minimized, thereby supporting a smooth monitoring service without a large overload.

In addition, according to the method of controlling the access to the monitoring target terminal of the present invention, when access to the DVR server or monitoring target terminal from a user is requested, a server authentication token or terminal authentication token held by the user is checked to perform an access authorization procedure thereon, so that security can be maintained without undergoing a complex and burdensome user authentication procedure.

Meanwhile, the above-described embodiments of the present invention can be programmed as a program which can be executed on a computer, and can be implemented in a general-purpose digital computer executing the program using a recording medium readable in the computer.

Preferred embodiments of the present invention have been disclosed herein and, although specific terms are employed, they are used and are to be interpreted in a generic and descriptive sense only and not for purposes of limitation. Accordingly, it will be understood by those of ordinary skill in the art that various changes in form and details may be made without departing from the spirit and scope of the present invention as set forth in the following claims.

1. A method of controlling access to a monitoring target terminal by a client terminal connected to a Digital Video Recorder (DVR) server through a network in a network-based DVR system, the method comprising the steps of:
(a) performing authentication on a user of the client terminal;
(b) providing a server authentication token when the authentication for the user of the client terminal is valid;
(c) providing a terminal authentication token required for accessing the monitoring target terminal to the client terminal; and
(d) accessing the corresponding monitoring target terminal using the provided terminal authentication token.

2. The method according to claim 1, wherein the monitoring target terminal is a video transmitting device or a digital video storing device.

3. The method according to claim 1, wherein the step of providing the server authentication token further comprises:
a first step of generating the server authentication token based on a MAC address of the DVR server and current time information in the DVR server;
a second step of including the generated server authentication token in an authentication success message in the DVR server and transmitting the message to the client terminal; and
a third step of receiving the authentication success message to extract and store the server authentication token in the client terminal.

4. The method according to claim 3, wherein the MAC address of the DVR server and generation time information of the server authentication token are encrypted with a predetermined encryption key to generate the server authentication token.

5. The method according to claim 3, wherein the third step further comprises a step of verifying integrity of the extracted server authentication token.

6. The method according to claim 1, wherein the step of providing the terminal authentication token further comprises:
a first step of selecting the monitoring target terminal;
a second step of including the server authentication token provided by step (b) in the client terminal in a terminal authentication token request message and transmitting the message to the DVR server;
a third step of receiving the terminal authentication token request message in the DVR server, and checking lifetime and performing verification on the server authentication token included in the terminal authentication token request message;
a fourth step of generating a terminal authentication token required for accessing the monitoring target terminal per monitoring target terminal in the DVR server when the server authentication token is determined to be valid and to have integrity through the third step;
a fifth step of including the terminal authentication token generated by the DVR server in a terminal authentication token transmission message and transmitting the message to the user of the client terminal; and
a sixth step of receiving the terminal authentication token transmission message in the client terminal to extract and store the terminal authentication token from the terminal authentication token transmission message.

7. The method according to claim 6, wherein the terminal authentication token request message includes a user ID, a MAC address of the client terminal, the server authentication token, the number of monitoring target terminals, a MAC address list of the monitoring target terminals, and a message authentication code about the MAC address list of the monitoring target terminals.

8. The method according to claim 6, wherein the third step further comprises the steps of:
decrypting the server authentication token to extract a MAC address of the DVR server and generation time information of the server authentication token;
determining whether the server authentication token is valid based on check of the MAC address of the DVR server, generation time information of the server authentication token, and lifetime information of the server authentication token; and
verifying integrity using a message authentication code about the MAC address list of the monitoring target terminal when the server authentication token is determined to be valid.

9. The method according to claim 6, wherein the fourth step further comprises the step of performing authentication on the user of the client terminal again when the server authentication token is determined to be invalid or modulated.

10. The method according to claim 6, wherein, in the fourth step, a MAC address of the monitoring target terminal, generation time of the terminal authentication token, and channel authorization information of the user are encrypted with a predetermined encryption key to generate the terminal authentication token.

11. The method according to claim 6, wherein the terminal authentication token transmission message includes a user ID, generation time of the terminal authentication token, the number of monitoring target terminals, a MAC address list of the monitoring target terminals, a terminal authentication token list, and authentication code information about the terminal authentication token list.

12. The method according to claim 6, wherein the sixth step further comprises the step of verifying integrity of the extracted terminal authentication token.

13. The method according to claim 1, wherein step (d) further comprises:
a first step of requesting access to the monitoring target terminal by the user of the client terminal;
a second step of including the terminal authentication token provided by step (c) in the client terminal in an access request message and transmitting the message to the corresponding monitoring target terminal;
a third step of receiving the access request message in the monitoring target terminal to perform lifetime check and verification of the terminal authentication token included in the access request message; and
a fourth step of authorizing access to the client terminal in the monitoring target terminal when the terminal authentication token is determined to be valid and to have integrity.

14. The method according to claim 13, further comprising:
the step of generating and providing the terminal authentication token again through step (c) when the terminal authentication token is determined to be invalid or modulated.

15. A method of controlling access to a monitoring target terminal through a client terminal connected to a Digital Video Recorder (DVR) server through a network in a network-based DVR system, the method comprising the steps of:
(a) performing authentication on a user of the client terminal;
(b) providing a server authentication token to the client terminal if the authentication for the user of the client terminal is valid; and
(c) accessing the corresponding monitoring target terminal using the provided server authentication token.

16. The method according to claim 15, wherein the monitoring target terminal is a video transmitting device or a digital video storing device.

17. The method according to claim 15, wherein the step of providing the server authentication token further comprises:
a first step of generating the server authentication token based on a MAC address of the DVR server and current time information in the DVR server;
a second step of including the generated server authentication token in an authentication success message in the DVR server and transmitting the message to the user of the client terminal; and
a third step of receiving the authentication success message to extract the server authentication token from the received authentication success message and to store the server authentication token in the client terminal.

18. The method according to claim 17, wherein, in the first step, the MAC address of the DVR server and generation time information of the server authentication token are encrypted with a predetermined encryption key to generate the server authentication token.

19. The method according to claim 15, wherein step (c) further comprises:
a first step of requesting access to the monitoring target terminal from the user of the client terminal;
a second step of including the server authentication token provided by step (b) in the client terminal in an access request message and transmitting the message to the DVR server;
a third step of receiving the access request message in the DVR server and checking a lifetime of the server authentication token included in the access request message;
a fourth step of transmitting an access authorization request message to the corresponding monitoring target terminal in the DVR server when the server authentication token is determined to be valid; and
a fifth step of authorizing access to the client terminal in the corresponding monitoring target terminal.

20. The method according to claim 19, wherein the third step further comprises the steps of:
decrypting the server authentication token to extract a MAC address of the DVR server and generation time information of the server authentication token;
determining whether the server authentication token is valid based on the extracted generation time information of the server authentication token and lifetime information of the server authentication token; and
verifying integrity using a message authentication code about the MAC address list of the monitoring target terminal when the server authentication token is determined to be valid.

21. A method of controlling access to a monitoring target terminal or a multimedia storing unit using a client terminal in a Digital Video Recorder (DVR) system including at least one monitoring target terminal, at least one client terminal, a multimedia storing unit and a DVR server, connected to each other through a network, the method comprising the steps of:
requesting user authentication of the client terminal to the DVR server;
receiving a server authentication token if the user authentication of the client terminal from the DVR server is valid;
requesting a terminal authentication token required for accessing the selected monitoring target terminal or the multimedia storing unit and receiving the terminal authentication token; and
requesting access to the corresponding monitoring target terminal using the terminal authentication token.

22. The method according to claim 21, wherein the monitoring target terminal is a video transmitting device or a digital video storing device.

23. The method according to claim 21, wherein the monitoring target terminal and the client terminal are wirelessly connected to the network.

24. The method according to claim 21, wherein a MAC address of the DVR server and generation time information of the server authentication token are encrypted with a predetermined encryption key to generate the server authentication token.

25. The method according to claim 21, wherein a MAC address of the monitoring target terminal or the multimedia storing unit, a generation time of the terminal authentication token, and access authority information of the monitoring target terminal or the multimedia storing unit are encrypted with a predetermined encryption key to generate the terminal authentication token.

26. A DVR server in a network-based Digital Video Recorder (DVR) system including at least one monitoring target terminal, at least one client terminal, and the DVR server connected to each other through a network, the DVR server comprising:
a communication unit for communicating with an external side;
an authentication and security control unit for controlling user authentication and security;
an authentication token generation unit for generating a server authentication token proving that a user of the client terminal is a valid user and a terminal authentication token proving that the user is one accessible to the monitoring target terminal under the control of the authentication and security control unit; and
an authentication token verification unit for verifying whether the server authentication token and the terminal authentication token provided by the user of the client terminal user are valid under the control of the authentication and security control unit.

27. The DVR server according to claim 26, wherein information about the generated server authentication token comprises the server authentication token, a MAC address of the DVR server, a generation time of the server authentication token, a lifetime of the server authentication token, channel authority information of a user, and an encryption/decryption key for generating and verifying an authentication token.

28. The DVR server according to claim 26, wherein information about the generated terminal authentication token comprises the terminal authentication token, a MAC address of the monitoring target terminal, a generation time of the terminal authentication token, a lifetime of the terminal authentication token, channel authority information of a user, and an encryption/decryption key for generating and verifying an authentication token.

29. The DVR server according to claim 26, wherein the server authentication token is generated by encrypting the MAC address of the DVR server and the generation time information of the server authentication token with a predetermined encryption key.

30. The DVR server according to claim 27, wherein the server authentication token is generated by encrypting the MAC address of the DVR server and the generation time information of the server authentication token with a predetermined encryption key.

31. The DVR server according to claim 26, wherein the terminal authentication token is generated by encrypting the MAC address of the monitoring target terminal, the generation time of the terminal authentication token, and channel authority information, with a predetermined encryption key.

32. The DVR server according to claim 28, wherein the terminal authentication token is generated by encrypting the MAC address of the monitoring target terminal, the generation time of the terminal authentication token, and channel authority information, with a predetermined encryption key.

33. The DVR server according to claim 26, wherein the authentication token verification unit comprises:
a determining unit for determining whether the server authentication token is valid based on the lifetime information of the server authentication token among information about the generated server authentication token and generation time information of the server authentication token obtained from the server authentication token provided from the user of the client terminal; and
a verifying unit for verifying integrity of the server authentication token using a message authentication code about a MAC address list of the monitoring target terminal when the server authentication token is determined to be valid.
